(19) United States
(12) Patent Application Publication
(10) Pub. No.: US 2026/0153322 A1
(43) Pub. Date: Jun. 4, 2026

(54) POSITION DETECTION DEVICE

(71) Applicant: Wacom Co., Ltd., Saitama (JP)

(72) Inventor: Tomohiko HIRANUMA, Saitama (JP)

(73) Assignee: Wacom Co., Ltd., Saitama (JP)

(21) Appl. No.: 19/457,984

(22) Filed: Jan. 23, 2026

Related U.S. Application Data
(63) Continuation of application No. PCT/JP2024/028044, filed on Aug. 6, 2024.

(30) Foreign Application Priority Data
Aug. 15, 2023 (JP) 2023-132321

(51) Int. Cl. G01B 7/008; G01L 1/14; G06F 3/0354; G06F 3/038; G06F 3/041; G06F 3/046

(52) U.S. Cl. CPC G01B 7/008; G01L 1/142; G06F 3/03545; G06F 3/0383; G06F 3/04162; G06F 3/046; G06F 2203/0384

(57) ABSTRACT

Provided is a position detection apparatus that detects a position indicated on a position detection sensor by an electronic pen including a resonant circuit that changes a resonance frequency according to a pen pressure applied, and also detects a pen pressure applied to the electronic pen, by performing interaction of a signal through electromagnetic induction coupling with the electronic pen. The position detection apparatus includes a signal transmission circuit that outputs a signal for the interaction, a receiving circuit that receives, via the position detection sensor, a feedback signal from the resonant circuit of the electronic pen for a signal transmitted from the signal transmission circuit via the position detection sensor, and a control circuit that supplies a control signal for changing a frequency of the signal to the signal transmission circuit.

### BACKGROUND

### Technical Field

The present disclosure relates to a position detection apparatus that detects a position indicated by an electronic pen and also detects a pen pressure applied to the electronic pen, through electromagnetic induction coupling with the electronic pen.

### Description of the Related Art

A position detection apparatus of an electromagnetic induction type that detects a position indicated by an electronic pen on a position detection sensor and also detects a pen pressure applied to the electronic pen, by performing interaction of a signal with the electronic pen through electromagnetic induction coupling, has come into widespread use (see, for example, Japanese Patent Laid-open No. 2012-133704).

FIG. 6 illustrates a circuit configuration example of each of an electronic pen 1 and a position detection apparatus 2 as an example of this electromagnetic induction type. As illustrated in FIG. 6, the electronic pen 1 includes a resonant circuit 10R in which a coil 11, a capacitor 12 arranged on a printed circuit board, and a variable-capacitance capacitor 13 including a pressure detecting section are connected in parallel. When a pen pressure is applied to the electronic pen 1, the capacity of the variable-capacitance capacitor 13 increases, and a resonance frequency of the resonant circuit 10R accordingly changes, allowing the position detection apparatus 2 to detect the pen pressure through detection of the change in the resonance frequency as described later.

Meanwhile, the position detection apparatus 2 includes a position detection sensor 21 that is formed by an X-axis direction loop coil group 21X and a Y-axis direction loop coil group 21Y being stacked and that is electromagnetically coupled with the resonant circuit 10R of the electronic pen 1.

The loop coil group 21X includes, for example, n rectangular loop coils, while the loop coil group 21Y includes, for example, m rectangular loop coils. The loop coils included in each of the loop coil groups 21X and 21Y are arranged side by side at regular intervals in such a manner as to be sequentially overlapped.

The position detection apparatus 2 further has a selection circuit 22 to which the X-axis direction loop coil group 21X and the Y-axis direction loop coil group 21Y of the position detection sensor 21 are connected. The selection circuit 22 sequentially selects one or a plurality of loop coils of the two loop coil groups 21X and 21Y, under the control by a processing control circuit 29 to be described later.

Further, the position detection apparatus 2 includes an oscillator 23, a current driver 24, a switching connection circuit 25, a reception amplifier 26, a position detection circuit 27, a pen pressure detection circuit 28, and the processing control circuit 29. The position detection circuit 27 includes a detector 271, a low-pass filter 272, a sample and hold circuit 273, and an analog-to-digital (A/D) conversion circuit 274. The pen pressure detection circuit 28 includes a synchronous detector 281, a low-pass filter 282, a sample and hold circuit 283, and an A/D conversion circuit 284. The processing control circuit 29 includes a microprocessor.

The oscillator 23 generates an alternating current (AC) signal with a predetermined frequency, for example, a frequency f0 of approximately 500 to 600 kHz and supplies the generated AC signal to the current driver 24 and the synchronous detector 281 of the pen pressure detection circuit 28. The current driver 24 converts the AC signal supplied from the oscillator 23 to a current and sends the current to the switching connection circuit 25. The switching connection circuit 25 switches the connection target (transmission-side terminal T or reception-side terminal R) to which the loop coil selected by the selection circuit 22 is to be connected, according to a control signal from the processing control circuit 29. In regard to the connection targets, the current driver 24 is connected to the transmission-side terminal T, while the reception amplifier 26 is connected to the reception-side terminal R.

When the switching connection circuit 25 is connected to the transmission-side terminal T by the processing control circuit 29, the signal from the oscillator 23 is supplied to the position detection sensor 21 through the current driver 24, the switching connection circuit 25, and the selection circuit 22, and transmitted from the loop coil selected by the selection circuit 220 under the control by the processing control circuit 29.

When the switching connection circuit 25 is connected to the reception-side terminal R by the processing control circuit 29, an induced voltage generated in the loop coil selected by the selection circuit 22 (a feedback signal from the resonant circuit 10R) is sent from the selection circuit 22 to the reception amplifier 26 through the switching connection circuit 25. This feedback signal is a signal corresponding to the resonance frequency of the resonant circuit 10R. The reception amplifier 26 amplifies the induced voltage supplied from the loop coil and sends the amplified induced voltage to the detector 271 of the position detection circuit 27 and the synchronous detector 281 of the pen pressure detection circuit 28.

The detector 271 of the position detection circuit 27 detects the induced voltage generated in the loop coil, that is, the feedback signal from the resonant circuit 10R, and sends it to the low-pass filter 272. The low-pass filter 272 has a cutoff frequency sufficiently lower than the frequency f0 described above. The low-pass filter 272 converts an output signal of the detector 271 to a direct current (DC) signal and sends it to the sample and hold circuit 273. The sample and hold circuit 273 holds a voltage value of an output signal of the low-pass filter 272 at a predetermined timing, that is, a predetermined timing during a reception period. This voltage value indicates a received signal level of the feedback signal from the resonant circuit 10R. In this example, the reception amplifier 26 and the position detection circuit 27 play the role of a receiving circuit for the feedback signal from the electronic pen 100.

The sample and hold circuit 273 sends the voltage value it holds to the A/D conversion circuit 274. The A/D conversion circuit 274 converts an analog output of the sample and hold circuit 273 to a digital signal and outputs the digital signal to the processing control circuit 29.

Further, the synchronous detector 281 of the pen pressure detection circuit 28 synchronously detects an output signal of the reception amplifier 26 by an AC signal from the oscillator 23 and sends a signal of a level corresponding to a frequency difference or a phase difference between the two signals to the low-pass filter 282. The low-pass filter 282 has a cutoff frequency sufficiently lower than the frequency f0 of the AC signal from the oscillator 23. The low-pass filter 282 converts the output signal of the synchronous detector 281 to a DC signal and sends it to the sample and hold circuit 283. The sample and hold circuit 283 holds a voltage value of an output signal of the low-pass filter 282 at a predetermined timing and sends this voltage value to the A/D conversion circuit 284. The A/D conversion circuit 284 converts the analog output of the sample and hold circuit 283 to a digital signal and outputs the digital signal to the processing control circuit 29.

The processing control circuit 29 controls selection of loop coils in the selection circuit 22, switching of the switching connection circuit 25, and sample and hold timing in the sample and hold circuits 273 and 283. Further, the processing control circuit 29 causes radio waves to be transmitted from the X-axis direction loop coil group 21X and the Y-axis direction loop coil group 21Y for a certain period of transmission continuation time (continuous transmission duration), based on input signals from the A/D conversion circuits 274 and 284.

As described above, in each loop coil of the X-axis direction loop coil group 21X and the Y-axis direction loop coil group 21Y, an induced voltage is generated by the radio waves transmitted (fed back) from the resonant circuit 10R of the electronic pen 1. The processing control circuit 29 calculates coordinate values in an X-axis direction and a Y-axis direction of the position indicated by the electronic pen 1, based on the recognition as to which of the loop coils the loop coil selected in the selection circuit 22 is and the level of the voltage value of the induced voltage generated in the loop coil (output of the A/D conversion circuit 274). Further, the processing control circuit 29 detects the pen pressure, based on the level of a signal corresponding to the frequency difference or the phase difference between the transmitted radio wave and the received radio wave.

In the manner described above, the position detection apparatus 2 of the electromagnetic induction type transmits an AC signal with a predetermined frequency f0 to the electronic pen 1 and receives a signal fed back as a signal corresponding to the resonance frequency from the resonant circuit 10R of the electronic pen 1, to thereby detect the position indicated by the electronic pen 1 and also detect the value of pen pressure applied to the electronic pen 1.

In this case, in the position detection apparatus 2 in the related art, the frequency f0 of an AC signal from the oscillator 23 is selected to be a predetermined frequency as follows such that the frequency f0 is appropriate for detecting the position indicated by the electronic pen 1 and also detecting the pen pressure.

The resonance frequency of the resonant circuit 10R of the electronic pen 1 is not constant as illustrated in FIGS. 7A and 7B and transitions to decrease from a resonance frequency fr0 in a state in which no pen pressure is applied to the electronic pen 1 (in the following description, this state is called an initial state for the sake of convenience), according to a magnitude of the pen pressure applied to the electronic pen 1, as illustrated by an arrow. That is, a resonance frequency fr of a resonant circuit including a coil (inductance L) and a capacitor (capacity C) is as follows.

fr∝½π(LC)^{1/2}

The capacitance of the pen pressure detecting section increases according to the pen pressure applied. Hence, when a pen pressure is applied to the electronic pen 1, the resonance frequency fr changes to be lower than the resonance frequency fr0 in the initial state according to the pen pressure as illustrated by dotted lines in FIGS. 7A and 7B.

Accordingly, in the position detection apparatus 2, when the frequency f0 of the AC signal from the oscillator 23 is selected to be equal to the resonance frequency fr0 in the initial state of the electronic pen 1 as illustrated in FIG. 7A (f0=fr0), the signal intensity of the feedback signal from the electronic pen 1 that is detected by the position detection apparatus 2 would, as illustrated by a bold line in FIG. 7A, decrease as the pen pressure increases, posing a problem of narrowing the pen pressure change range detectable by the position detection apparatus 2.

In view of this, in the related art, as illustrated in FIG. 7B, the frequency f0 of the AC signal from the oscillator 23 is set to a frequency frc that is lower than the resonance frequency fr0 in the initial state. Setting the frequency f0 of the AC signal from the oscillator 23 to the frequency frc that is lower than the resonant frequency fr0 in the initial state as described above allows the signal intensity of the feedback signal from the electronic pen 1 to exhibit the maximum value of pen pressure at the frequency frc with respect to the change in the pen pressure, as illustrated by a bold line in FIG. 7B, so that the pen pressure detection range in the position detection apparatus 2 can be made wider than in the case in which the frequency f0 of the AC signal is set to the resonance frequency fr0 in the initial state.

However, in a case where the frequency f0 of the AC signal from the oscillator 23 of the position detection apparatus 2 is made lower than the resonance frequency fr0 in the initial state, when the resonant circuit 10R of the electronic pen 1 is in the initial state, the signal intensity of the feedback signal from the electronic pen 1 would be lower than in the case in which the frequency f0 of the AC signal is made equal to the resonance frequency fr0 in the initial sate (see FIG. 7B). Hence, in the position detection apparatus 2, the height, from the input surface of the position detection apparatus 2, of the electronic pen 1 that is in what is generally called a hovering state in which the electronic pen 1 is not in contact with the input surface but is able to perform interaction of a signal through electromagnetic induction coupling becomes low, posing the problem of making the electronic pen 1 less user friendly.

In the related art, in view of this problem, when the height of the electronic pen 1 in the hovering state from the input surface of the position detection apparatus 2 is to be raised, the signal intensity of the AC signal with the frequency f0 from the oscillator 23 of the position detection apparatus 2 had been increased. However, increasing the signal intensity caused another problem of the position detection apparatus 2 consuming more power.

### BRIEF SUMMARY

The present disclosure provides a position detection apparatus that can solve the abovementioned problems.

In order to solve the problems described above, there is provided a position detection apparatus that detects a position indicated on a position detection sensor by an electronic pen including a resonant circuit that changes a resonance frequency according to a pen pressure applied, and also detects a pen pressure applied to the electronic pen, by performing interaction of a signal through electromagnetic induction coupling with the electronic pen. The position detection apparatus includes a signal transmission circuit that outputs a signal for the interaction, a receiving circuit that receives, via the position detection sensor, a feedback signal from the resonant circuit of the electronic pen for a signal transmitted from the signal transmission circuit via the position detection sensor, and a control circuit that supplies a control signal for changing a frequency of the signal to the signal transmission circuit. The control circuit switches, by the control signal, a frequency of the signal from the signal transmission circuit from a first frequency that is equal to a resonance frequency of the resonant circuit when a pen pressure is not applied to the electronic pen to a second frequency that is different from the first frequency in a direction in which the resonance frequency changes according to the pen pressure, when a signal level of the feedback signal received by the receiving circuit is detected to be equal to or higher than a predetermined threshold.

According to the position detection apparatus having the configuration described above, when the signal level of the feedback signal is equal to or higher than a predetermined threshold, the frequency of the signal from the signal transmission circuit is switched from the first frequency that is equal to the resonance frequency of the resonant circuit when a pen pressure is not applied to the electronic pen to a second frequency that is different from the first frequency in a direction in which the resonance frequency changes according to the pen pressure. This allows the feedback signal from the resonant circuit of the electronic pen to be received at high level at all times. Accordingly, the height of the electronic pen that enters the hovering state from the input surface of the portion detection apparatus can be raised compared to the related art. In this case, the signal intensity need not be made higher, so that the power consumption does not increase.

Further, at the time of detecting the pen pressure applied to the electronic pen, the frequency is switched to the second frequency in a direction in which the resonance frequency changes according to the pen pressure, so that the pen pressure can be detected within an appropriate detection range.

### BRIEF DESCRIPTION OF THE SEVERAL VIEWS OF THE DRAWINGS

FIG. 1 is a diagram illustrating an example of an appearance of a position detection apparatus according to an embodiment of the present disclosure and an electronic pen according to an embodiment of the present embodiment.

FIG. 2 is an exploded perspective view illustrating an internal configuration example of the position detection apparatus according to the embodiment of the present disclosure.

FIG. 3 is a diagram illustrating an electrical configuration example of the position detection apparatus according to the embodiment of the present disclosure and an electrical configuration example of the electronic pen according to the embodiment of the present disclosure.

FIGS. 4A and 4B are each a diagram used for describing a configuration of a main part of the position detection apparatus according to the embodiment of the present disclosure.

FIG. 5 is a diagram illustrating a flowchart for describing an operation of the main part of the position detection apparatus according to the embodiment of the present disclosure.

FIG. 6 is a diagram illustrating an electrical configuration example of a position detection apparatus in the related art and an electrical configuration example of an electronic pen in the related art.

FIGS. 7A and 7B are each a diagram for describing setting of a frequency of an AC signal that is sent to the electronic pen in the position detection apparatus in the related art.

### DETAILED DESCRIPTION

A position detection apparatus according to an embodiment of the present disclosure is hereinafter described together with an example of an electronic pen in reference to the drawings.

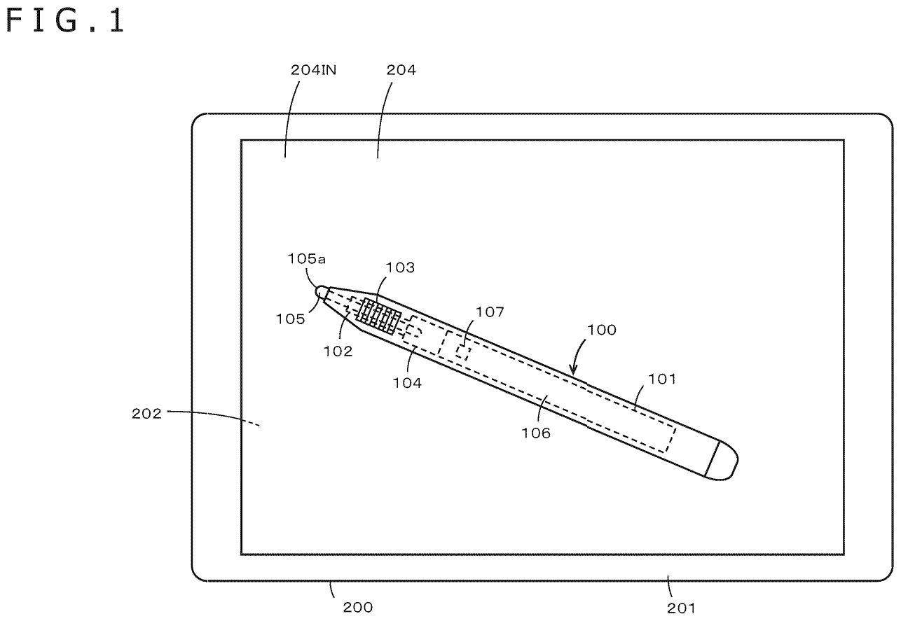

FIG. 1 is a diagram illustrating an example of a position detection apparatus 200 according to the embodiment and an electronic pen 100 used together with the position detection apparatus 200. The position detection apparatus 200 according to the embodiment has the configuration of a tablet-type information terminal.

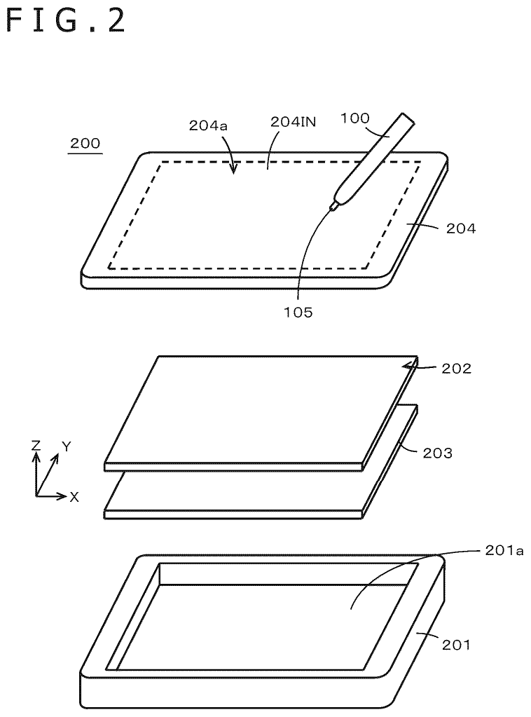

In the present example, the position detection apparatus 200 includes a position detection sensor 202 of an electromagnetic induction type and a circuit board 203 inside a flat, rectangular casing 201. FIG. 2 is an exploded configuration diagram of the position detection apparatus 200. The position detection sensor 202 and the circuit board 203 are housed in a housing recess 201a of the casing 201, and an upper portion of the housing recess 201a of the casing 201 is closed by a planar member 204.

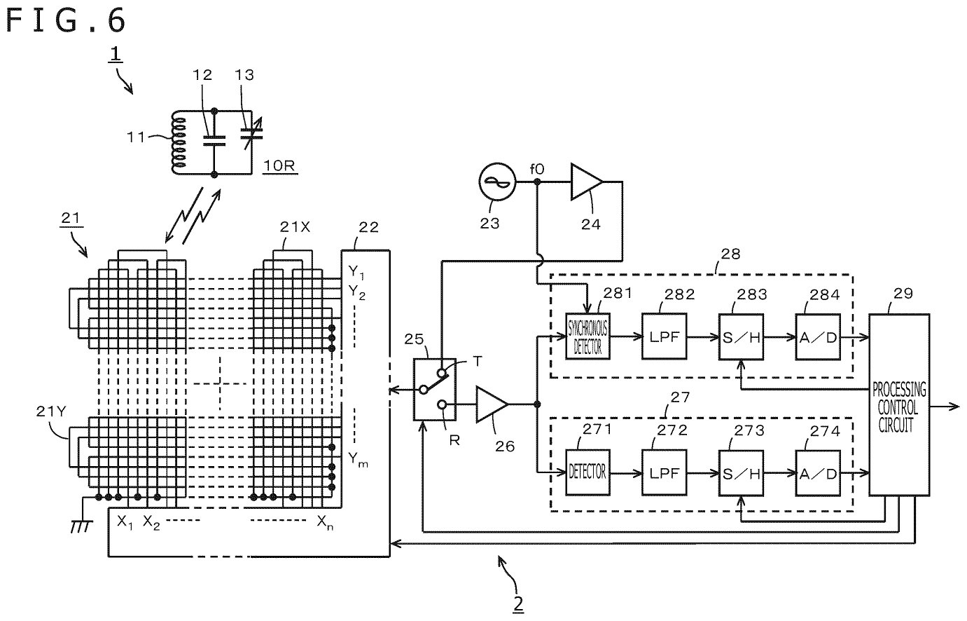

The position detection sensor 202 has a configuration similar to that in the example illustrated in FIG. 6 and includes an X-axis direction loop coil group 201X and a Y-axis direction loop coil group 201Y. The circuit board 203 is, similarly to the example illustrated in FIG. 6, formed with a circuit section connected to the position detection sensor 202. The planar member 204 has one surface 204a serving as an input surface side that is used when position indication is made by the electronic pen 100.

In the present example, the planar member 204 has a shape slightly larger than a position detection area of the position detection sensor 202. In the planar member 204 illustrated in FIG. 2, an area illustrated by being surrounded by a dotted line is an area corresponding to the position detection area of the position detection sensor 202, and is an area of an input surface 204IN at which position indication by the electronic pen 100 is received.

In the electronic pen 100 of an electromagnetic induction type in the present example, as illustrated in FIG. 1, a coil 103 wound around a magnetic core, for example, a ferrite core 102, is provided on a pen tip side of a hollow portion of a tube-shaped casing 101. On a side opposite the pen tip side of the ferrite core 102 in an axial direction of the hollow portion of the casing 101, a pen pressure detecting section 104 is provided, and a rod-shaped core body 105 is inserted through a penetration hole (omitted from illustration) provided in the ferrite core 102 from an opening on the pen tip side of the casing 101, and fitted and attached to the pen pressure detecting section 104. The core body 105 has a distal end portion 105a protruding outward from the opening on the pen tip side of the casing 101.

On the side opposite the pen tip side of the pen pressure detecting section 104 in the axial direction of the hollow portion of the casing 101, a circuit board 106 is arranged. In this circuit board 106, there is arranged a capacitor 107 that is connected in parallel to the coil 103 wound around the ferrite core 102 and configures a resonant circuit.

Further, in the present example, the pen pressure detecting section 104 has a configuration of a variable-capacitance capacitor that detects a pressure (pen pressure) applied to the distal end portion 105a of the core body 105 as a change in capacitance. The pen pressure detecting section 104 has a known configuration such as a configuration in which the capacitance changes by a change in the area of contact between a dielectric and a conductive elastic material according to the pressure applied (refer, for example, to Japanese Patent Laid-open No. 2016-126503) or a configuration including a semiconductor device in which a distance between two electrodes that face each other via an air layer that is a dielectric changes according to the pressure applied (refer to, for example, Japanese Patent Laid-open No. 2013-161307). Hence, in the present specification, detailed description of the pen pressure detecting section 104 is omitted.

In the present example, the variable-capacitance capacitor including the pen pressure detecting section 104 is one that is connected in parallel to the coil 103 and configures part of the resonant circuit. Further, as described above, the variable-capacitance capacitor is configured to transmit the pen pressure detected by the pen pressure detecting section 104 to the position detection sensor 202 side as a change in the resonance frequency of the resonant circuit.

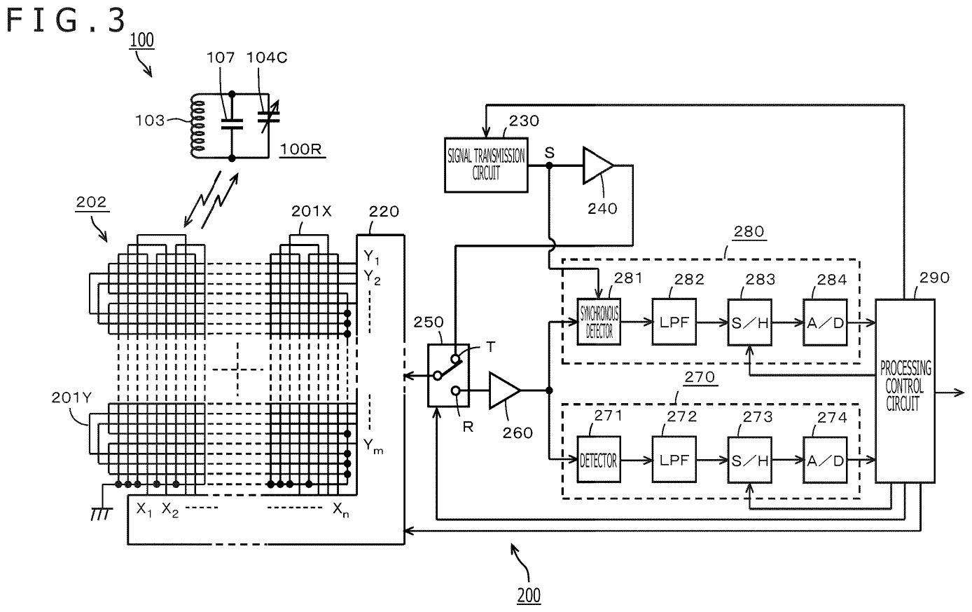

FIG. 3 illustrates a circuit configuration example of the position detection apparatus 200 according to the present embodiment and a circuit configuration example of the electronic pen 100 according to the present embodiment. A resonant circuit 100R of the electronic pen 100 has a configuration in which the capacitor 107 is connected in parallel to the coil 103 and a variable-capacitance capacitor 104C including the pen pressure detecting section 104 is connected in parallel to the coil 103. The resonant circuit 100R has a configuration that is completely the same as that of the electronic pen 1 illustrated in FIG. 6, and thus has the same resonance frequency characteristics described above.

That is, the resonant circuit 100R configures an interaction section for performing internation of a signal with the position detection sensor 202 as described above, and operates to receive, by resonance, a signal sent from the position detection sensor 202 and transmit a feedback signal to the position detection sensor 202.

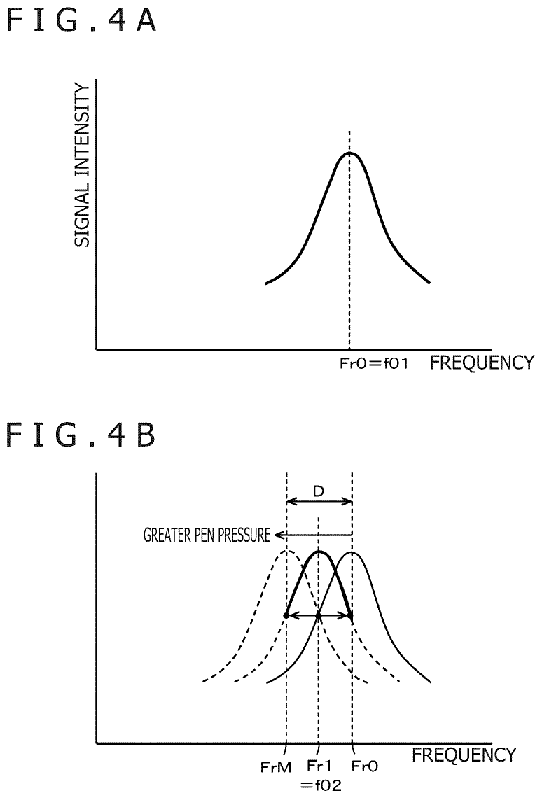

Further, the resonance frequency of the resonant circuit 100R is set to a predetermined frequency Fr0, in an initial state in which the core body 105 of the electronic pen 100 is not in contact with the input surface 204IN of the position detection apparatus 200 and thus a pen pressure is not applied thereto (see FIG. 4A). In contrast, in a state in which the core body 105 of the electronic pen 100 comes into contact with the input surface 204IN of the position detection apparatus 200 and a pen pressure is applied thereto, the resonance frequency of the resonant circuit 100R changes to a lower frequency that is equal to or lower than the predetermined frequency Fr0 according to a change in the capacitance of the variable-capacitance capacitor 104C corresponding to the pen pressure value detected by the pen pressure detecting section 104 (see FIG. 4B). Note that the resonance frequency of the resonant circuit 100R is, in the present example, a frequency of approximately 500 to 600 kHz as in the related art.

The position detection apparatus 200 according to the present embodiment includes a selection circuit 220 to which the X-axis direction loop coil group 201X and the Y-axis direction loop coil group 201Y of the position detection sensor 202 are connected, as illustrated in FIG. 3. Further, the position detection apparatus 200 according to the present embodiment includes a signal transmission circuit 230, a current driver 240, a switching control circuit 250, a reception amplifier 260, a position detection circuit 270, a pen pressure detection circuit 280, and a processing control circuit 290.

The position detection apparatus 200 according to the present embodiment only differs from the position detection apparatus 2 described above in being provided with the signal transmission circuit 230 in place of the oscillator 23 and having the frequency of the signal output from the signal transmission circuit 230 being controlled by the processing control circuit 290 and has the same configuration as the position detection apparatus 2 in other respects. The position detection apparatus 200 also performs the same operation as those of the position detection apparatus 2.

As illustrated in FIG. 3, the position detection circuit 270 includes a detector 271, a low-pass filter 272, a sample and hold circuit 273, and an A/D conversion circuit 274, similarly to the position detection circuit 27 described above. Further, the pen pressure detection circuit 280 includes a synchronous detector 281, a low-pass filter 282, a sample and hold circuit 283, and an A/D conversion circuit 284, similarly to the pen pressure detection circuit 28 described above. Further, the processing control circuit 290 includes a microprocessor.

The selection circuit 220 sequentially selects one or a plurality of loop coils of the two loop coil groups 201X and 201Y, under the control by the processing control circuit 290. Further, when the switching control circuit 250 is connected to the transmission-side terminal T by the processing control circuit 290, an AC signal S from the signal transmission circuit 230 is supplied to the selection circuit 220 through the current driver 240 and the switching control circuit 250 and is transmitted from the loop coil selected by the selection circuit 220 under the control by the processing control circuit 290.

When the switching control circuit 250 is connected to the reception-side terminal R by the processing control circuit 290, the feedback signal from the resonant circuit 100R of the electronic pen 100 received by the loop coil selected by the selection circuit 220 under the control by the processing control circuit 290 is supplied to the position detection circuit 270 and the pen pressure detection circuit 280 through the selection circuit 220, the switching control circuit 250, and the reception amplifier 260.

The position detection circuit 270 supplies a digital signal indicating a received signal level of the received feedback signal to the processing control circuit 290, as described above. The processing control circuit 290 calculates coordinate values in an X-axis direction and a Y-axis direction of the position indicated by the electronic pen 100, based on a recognition as to which of the loop coils the loop coil selected by the selection circuit 220 is and the level of the voltage value of the induced voltage generated in the selected loop coil (the output of the A/D conversion circuit 274).

The pen pressure detection circuit 280 supplies a digital signal indicating the level corresponding to a frequency difference or a phase difference between the transmitted signal (radio wave) and the received signal (radio wave) to the processing control circuit 290. The processing control circuit 290 detects the pen pressure applied to the distal end portion 105a of the core body 105 of the electronic pen 100, based on the digital signal.

The signal transmission circuit 230 of the position detection apparatus 200 according to the present embodiment includes a variable frequency oscillator in the present example, and is configured to switch the frequency of the AC signal S sent from the signal transmission circuit 230 to a first frequency f01 or a second frequency f02, by the control signal from the processing control circuit 290.

In the present embodiment, the first frequency f01 is set to a frequency equal to the resonance frequency Fr0 in the initial state of the electronic pen 100 illustrated in FIG. 4A. Further, the second frequency f02 in the present example is set to a frequency Fr1 corresponding to a median value in a pen pressure detection range (a frequency change range (or a phase shift range) corresponding to a change range of the pen pressure to be detected) D in the position detection apparatus 200 in FIG. 4B. That is, as illustrated in FIG. 4B, the pen pressure detection range D in the position detection apparatus 200 is a frequency equal to or lower than the resonance frequency Fr0 of the resonant circuit 100R in the initial state of the electronic pen 100 and is a frequency up to a resonance frequency FrM of the resonant circuit 100R at the time of the detectable maximum pen pressure value. Hence, the frequency Fr1 corresponding to the median value in the pen pressure detection range D is a frequency lower than the resonance frequency Fr0 by ΔF=(Fr0−FrM)/2, while the second frequency f02 is f02=f01−ΔF=Fr1. Note that Fr1=(Fr0+FrM)/2 also holds.

Further, the processing control circuit 290 controls the frequency of the AC signal S from the signal transmission circuit 230 to the first frequency f01 when scanning to detect at least the electromagnetic induction coupling between the position detection apparatus 200 (position detection sensor 202) and the electronic pen 100 and further controls the frequency of the AC signal S from the signal transmission circuit 230 to the second frequency f02 when detecting the pen pressure applied to the electronic pen 100. That is, the processing control circuit 290 controls the frequency of the AC signal S from the signal transmission circuit 230 to the first frequency f01 until at least the electromagnetic induction coupling is established between the electronic pen 100 and the position detection sensor 202 and the electronic pen 100 enters the hovering state. Moreover, at least when the electronic pen 100 comes into contact with the input surface 204 IN of the position detection apparatus 200 and a pen pressure is applied thereto, the processing control circuit 290 controls the frequency of the AC signal S from the signal transmission circuit 230 to the second frequency f02, in order to detect the pen pressure.

In the present embodiment, the processing control circuit 290 controls the frequency of the AC signal S from the signal transmission circuit 230 to the first frequency f01 as a scan mode for detecting the electromagnetic induction coupling between the position detection apparatus 200 (position detection sensor 202) and the electronic pen 100 while the signal level of the feedback signal from the electronic pen 100 that is represented by a digital signal output from the A/D conversion circuit 274 of the position detection circuit 270 is lower than a predetermined threshold θ. When the signal level of the feedback signal from the electronic pen 100 becomes equal to or higher than the threshold θ, the processing control circuit 290 determines that the electronic pen 100 has entered the hovering state and controls the frequency of the AC signal S from the signal transmission circuit 230 to the second frequency f02.

In this example, the threshold θ is set to a signal level by which the electronic pen 100 entering the hovering state on the input surface 204IN of the position detection apparatus 200 can be detected. Hence, this example has a configuration in which, when the electronic pen 100 enters a hovering area, the frequency of the AC signal S from the signal transmission circuit 230 is switched to the second frequency f02 from the first frequency f01.

Yet, the threshold θ does not necessarily have to be set to such a value, and may be set to a value corresponding to the signal level of the feedback signal at the time when the electronic pen 100 is at any height position within the height range of the hovering area. That is, supposing that the signal level of the received signal at the height position of the electronic pen 100 at which the position detection apparatus 200 detects that the electronic pen 100 has entered what is generally called a hovering state in which the electronic pen 100 is not in contact with the input surface 204IN but is able to perform interaction of a signal through electromagnetic induction coupling (at a position at which the electronic pen 100 is most separated from the input surface 204 IN in the hovering state) is La and the signal level of the received signal at the height position at which the electronic pen 100 comes into contact with the input surface 204IN is Lb, the threshold θ is only required to be set to satisfy the relation of

La≥θ≥Lb.

Note that, in this case, needless to say, the processing control circuit 290 may set different values for the threshold for detecting that the electronic pen 100 has entered the hovering area and the threshold for switching between the first frequency f01 and the second frequency f02.

In the present embodiment, the signal transmission circuit 230 includes a frequency synthesizer oscillator using a phase locked loop (PLL) circuit and has a configuration in which the frequency of the AC signal S can be changed by changing an N value of a frequency division ratio of 1/N of the variable frequency divider.

Further, in the position detection apparatus 200 according to the present embodiment, a control signal CT1 for setting the frequency of the AC signal S from the signal transmission circuit 230 to the first frequency f01 is set in the following manner. Specifically, the position detection apparatus 200 of this example includes a setting mode for the first frequency f01 of the AC signal S from the signal transmission circuit 230. This setting mode is set by a worker at the time of factory shipment of the position detection apparatus 200; instead, this setting mode may be set by a user of the position detection apparatus 200 at any appropriate timing.

In this setting mode, the processing control circuit 290 controls of gradually changing the frequency of the AC signal S by supplying a control signal of an N value of the frequency division ratio of 1/N of the variable frequency divider to the signal transmission circuit 230, in a state in which the electronic pen 100 is maintained to be in the hovering state with respect to the position detection apparatus 200. Further, each time the frequency of the AC signal S from the signal transmission circuit 230 is changed, the processing control circuit 290 repeats an operation of switching the switching control circuit 250 to the terminal T side and then transmitting the AC signal S to the electronic pen 100 through the selection circuit 220 and the position detection sensor 202 and thereafter switching the switching control circuit 250 to the terminal R side and then supplying the feedback signal from the electronic pen 100 received by the position detection sensor 202 to the position detection circuit 270 through the selection circuit 220 and the switching control circuit 250.

Further, the processing control circuit 290 detects and monitors the signal level of the feedback signal from the electronic pen 100, based on the digital signal from the position detection circuit 270. Thereafter, the processing control circuit 290 finds an N value of the frequency division ratio of 1/N by which the AC signal S has a frequency at which the signal level of the feedback signal from the electronic pen 100 becomes maximum, and holds the N value as the control signal CT1. In this case, as illustrated in FIG. 4A, the frequency of the AC signal S at which the signal level of the feedback signal from the electronic pen 100 becomes maximum is substantially equal to the resonance frequency Fr0 in the initial state of the resonant circuit 100R of the electronic pen 100.

Accordingly, the processing control circuit 290 can set the frequency of the AC signal S from the signal transmission circuit 230 to the first frequency f01 (=Fr0) by supplying the control signal CT1 it holds to the signal transmission circuit 230.

Further, as a control signal CT2 for setting the frequency of the AC signal S from the signal transmission circuit 230 to the second frequency f02, in the present example, an N value of the frequency division ratio of 1/N that makes the frequency of the AC signal S lower than the frequency corresponding to the control signal CT1 by ΔF=(Fr0−FrM)/2 is held in the processing control circuit 290. By the control signal CT2 being supplied from the processing control circuit 290 to the signal transmission circuit 230, the frequency of the AC signal S is set to the second frequency f02 described above.

Note that, needless to say, each of the first frequency f01 and the second frequency f02 of the AC signal S from the signal transmission circuit 230 may in advance be set to a frequency determined based on the resonance frequency Fr0 of the resonant circuit 100R of the electronic pen 100 instead of being set in the manner described above.

Further, the signal transmission circuit 230 need not include a frequency synthesizer oscillator using a PLL circuit as in the present example and may be of any configuration that can output the frequency of the AC signal S by switching the frequency between the first frequency f01 and the second frequency f02. For example, the signal transmission circuit 230 may be configured such that an inductance value of a coil or a capacitance of the capacitor, which is a factor for changing the resonance frequency, is switched with use of a switch circuit, in an oscillation circuit included in the signal transmission circuit 230.

### Description Regarding Frequency Control Operation by Processing Control Circuit 290

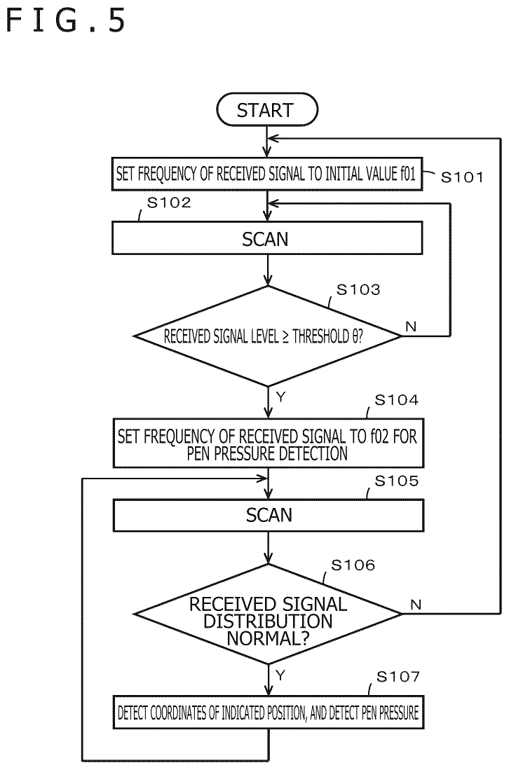

Next, a control operation of the signal transmission circuit 230 by the processing control circuit 290 in the position detection apparatus 200 according to the present embodiment is described with reference to a flowchart illustrated in FIG. 5. Note that the processing control circuit 290 executes this control operation in accordance with a software program stored in a built-in memory. In the following description, description is given on the assumption that the processing control circuit 290 processes each step S of the flowchart illustrated in FIG. 5.

The processing control circuit 290 supplies the control signal CT1 to the signal transmission circuit 230 and sets the frequency of the AC signal S output from the signal transmission circuit 230 to the first frequency f01 that is equal to the resonance frequency Fr0 in the initial state of the resonant circuit 100R of the electronic pen 100 (step S101). Next, the processing control circuit 290 transmits the AC signal S with the first frequency f01 through the position detection sensor 202 and receives a feedback signal from the resonant circuit 100R of the electronic pen 100, to thereby scan as to whether the electronic pen 100 has approached the input surface 204 IN of the position detection apparatus 200 for indication input (step S102).

Subsequently, the processing control circuit 290 detects a received signal level of the feedback signal from the electronic pen 100, based on the digital signal from the position detection circuit 270, in the scanning in step S102, and determines whether the received signal level has become equal to or higher than the threshold θ (step S103). When determining in step S103 that the received signal level of the feedback signal has not become equal to or higher than the threshold θ, the processing control circuit 290 returns the processing back to step S102 and repeats the scanning in step S102 and the determination processing in step S103.

When determining in step S103 that the received signal level of the feedback signal has become equal to or higher than the threshold θ, the processing control circuit 290 changes the control signal for the signal transmission circuit 230 from the control signal CT1 to the control signal CT2 and sets the frequency of the AC signal S output from the signal transmission circuit 230 to the second frequency f02 (=f01−ΔF) (step S104).

Following step S104, the processing control circuit 290 scans to detect the position indicated by the electronic pen 100 and to detect the pen pressure applied thereto (step S105). Then, the processing control circuit 290 determines whether the received signal distribution of the feedback signal is in a normal state, that is, the received signal distribution is the received signal distribution in the hovering area or in a state in which the distal end portion 105a of the core body 105 of the electronic pen 100 is in contact with the input surface 204IN (step S106).

When determining in step S106 that the received signal distribution of the feedback signal is in a normal state, the processing control circuit 290 detects the position indicated by the electronic pen 100, by using the digital signal from the position detection circuit 270, and also detects the pen pressure applied to the distal end portion 105a of the core body 105 of the electronic pen 100, by using the digital signal from the pen pressure detection circuit 280 (step S107). Following step S107, the processing control circuit 290 returns the processing back to step S105 and repeats the processing in step S105 and subsequent steps.

Further, when determining in step S106 that the received signal distribution of the feedback signal is not in a normal state, the processing control circuit 290 returns the processing back to S101, changes the control signal for the signal transmission circuit 230 from the control signal CT2 to the control signal CT1, and changes the frequency of the AC signal S output from the signal transmission circuit 230 back to the first frequency f0 that is equal to the resonance frequency Fr0 in the initial state of the resonant circuit 100R of the electronic pen 100. Then, the processing control circuit 290 repeats the processing in step S101 and subsequent steps.

### Advantageous Effect of Position Detection Apparatus 200 of Present Embodiment

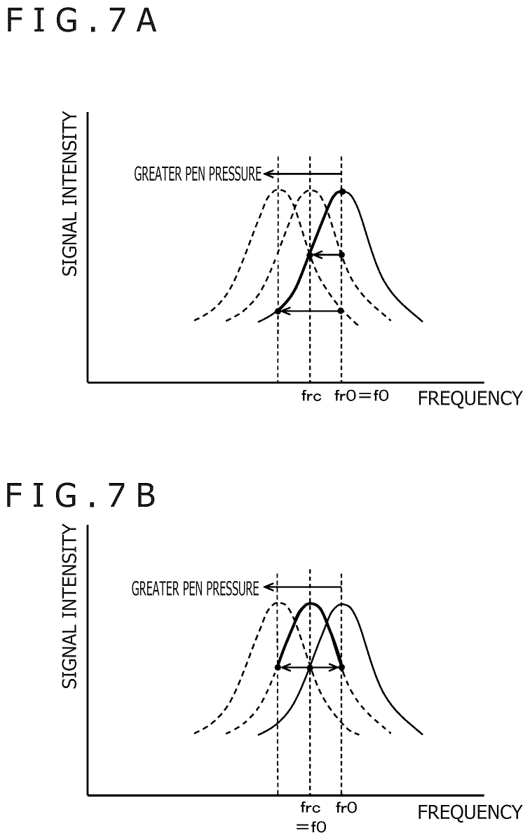

As described above, in the position detection apparatus 200 according to the present embodiment, when at least the electromagnetic induction coupling between the position detection apparatus 200 (position detection sensor 202) and the electronic pen 100 is to be tested, the frequency of the AC signal S from the signal transmission circuit 230 is controlled to the first frequency f01 that is equal to the resonance frequency Fr0 in the initial state of the resonant circuit 100R of the electronic pen 100, so that the signal level of the feedback signal from the electronic pen 100 can have a high signal intensity compared to that in the related art, at the time of scanning for the testing. Incidentally, it has been confirmed that the signal intensity can be made higher for approximately 30% to 40% in a case of setting the frequency of the AC signal S to the first frequency f01 compared to the case in which the frequency of the AC signal S is set to the frequency frc illustrated in FIG. 7B in the related art.

Further, in the position detection apparatus 200 of the present embodiment, at the time of detecting the pen pressure applied to the electronic pen 100, the frequency of the AC signal S from the signal transmission circuit 230 is switched from the first frequency f01 equal to the resonance frequency Fr0 in the initial state of the resonant circuit 100R of the electronic pen 100 for detecting the electromagnetic induction coupling state with the electronic pen 100 to the second frequency f02 that is used at the time of detecting the pen pressure. Further, in the position detection apparatus 200 of this embodiment, the second frequency f02 can be set to a median value in the pen pressure detection range D corresponding to the change range of the pen pressure to be detected, offering such an advantageous effect that the pen pressure in the pen pressure detection range D can be detected accurately.

Hence, according to the position detection apparatus 200 of the present embodiment, the height position detected as the hovering area can be raised without the signal intensity of the AC signal to be sent being increased, and the pen pressure applied to the pen tip of the electronic pen 100 can be accurately detected within a desired wide range.

### Other Embodiments or Modifications

In the position detection apparatus 200 of the embodiment described above, the frequency of the AC signal S from the signal transmission circuit 230 is switched between the first frequency f01 and the second frequency f02 when the electronic pen 100 has entered the hovering state with respect to the position detection apparatus 200, according to the signal level of the feedback signal from the electronic pen 100, but the configuration is not limited thereto. For example, the timing of switching the frequency of the AC signal S from the signal transmission circuit 230 between the first frequency f01 and the second frequency f02 may be set to any timing at which the electronic pen 100 is at any height position during a period from the time when the electronic pen 100 has entered the hovering state with respect to the position detection apparatus 200 to the timing when the pen tip of the electronic pen 100 comes into contact with the input surface 204 IN of the position detection apparatus 200. In this case, the threshold for determining the timing of switching the frequency between the first frequency f01 and the second frequency f02 is set to the received signal level of the feedback signal from the electronic pen 100 at any height position of each switching timing.

Note that the position detection apparatus 200 may be configured to monitor the pen pressure applied to the electronic pen 100 and switch the frequency of the AC signal S from the first frequency f01 to the second frequency f02 when the pen pressure value becomes equal to or higher than a threshold that is a value at the time when the electronic pen 100 comes into contact with the input surface 204IN or a value slightly greater than the value at the time when the electronic pen 100 has come into contact with the input surface 204IN or switch the frequency from the second frequency f02 to the first frequency f01 when the pen pressure value becomes lower than the threshold.

Moreover, in the abovementioned embodiment, the pen pressure detecting section of the electronic pen 100 has been configured to detect the pen pressure applied as a change in capacitance, but the pen pressure detecting section is not limited to such a configuration; for example, the pen pressure detection section may have a configuration in which the applied pen pressure is detected as a change in inductance.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A position detection apparatus that detects a position indicated on a position detection sensor by an electronic pen including a resonant circuit that changes a resonance frequency according to a pen pressure applied, and also detects a pen pressure applied to the electronic pen, by performing interaction of a signal through electromagnetic induction coupling with the electronic pen, the position detection apparatus comprising:
a signal transmission circuit that outputs a signal for the interaction;
a receiving circuit that receives, via the position detection sensor, a feedback signal from the resonant circuit of the electronic pen for a signal transmitted from the signal transmission circuit via the position detection sensor; and
a control circuit that supplies a control signal for changing a frequency of the signal to the signal transmission circuit, wherein
the control circuit switches, by the control signal, a frequency of the signal from the signal transmission circuit from a first frequency that is equal to the resonance frequency of the resonant circuit when a pen pressure is not applied to the electronic pen to a second frequency that is different from the first frequency in a direction in which the resonance frequency changes according to the pen pressure, when a signal level of the feedback signal received by the receiving circuit is detected to be equal to or higher than a predetermined threshold.

2. The position detection apparatus according to claim 1, wherein the control signal from the control circuit is a control signal for controlling the signal transmission circuit such that a signal of the first frequency and a signal of the second frequency are selectively output.

3. The position detection apparatus according to claim 1, wherein the signal transmission circuit includes a variable frequency oscillating circuit that is capable of changing a frequency of a signal to be output, based on the control signal from the control circuit.

4. The position detection apparatus according to claim 3, wherein the control circuit includes a control signal setting circuit that sequentially changes a frequency of an output signal of the signal transmission circuit by the control signal, monitors the signal level of the feedback signal from the electronic pen in a state in which the pen pressure is not applied, and sets the control signal at a time when the signal level of the feedback signal becomes maximum to a control signal for setting the frequency to the first frequency.

5. The position detection apparatus according to claim 1, wherein the second frequency is set according to a detection range of a pen pressure applied to the electronic pen.

6. The position detection apparatus according to claim 4, wherein the second frequency is set to a frequency corresponding to a median value in a detection range of a pen pressure applied to the electronic pen.

7. The position detection apparatus according to claim 1, further comprising:
a pen pressure detection circuit that detects a pen pressure applied to the electronic pen, according to a frequency difference or a phase difference between a signal from the signal transmission circuit and a feedback signal from the resonant circuit of the electronic pen, wherein,
when the pen pressure detected in the pen pressure detection circuit is detected to be equal to or higher than a predetermined value, the control circuit controls the signal transmission circuit such that a signal is switched from a signal of the first frequency to a signal of the second frequency.
